(19) United States
(12) Patent Application Publication
(10) Pub. No.: US 2017/0280424 A1
(43) Pub. Date: Sep. 28, 2017

(54) RESOURCE ALLOCATION SIGNALING IN UPLINK FRAMES IN WIRELESS NETWORKS

(71) Applicants: Chittabrata Ghosh, Fremont, CA (US); Yaron Alpert, Hod Hasharoni (IL)

(72) Inventors: Chittabrata Ghosh, Fremont, CA (US); Yaron Alpert, Hod Hasharoni (IL)

(21) Appl. No.: 15/077,257

(22) Filed: Mar. 22, 2016

(51) Int. Cl. H04W 72/04; H04B 7/04; H04L 29/08; H04L 5/00

(52) U.S. Cl. CPC H04W 72/042; H04L 5/0007; H04B 7/0452; H04L 69/324; H04W 84/12

(57) ABSTRACT

Apparatuses, computer readable media, and methods for resource allocation signaling in uplink frames in wireless networks are disclosed. An apparatus of an access point including processing circuitry is disclosed. The processing circuitry may be configured to encode a first frame and encode second frames for one or both of DL OFDMA or MU-MIMO. The second frames may include data for a plurality of stations. The processing circuitry may be configured to encode a resource allocation for each of the plurality of stations to transmit one or more third frames comprising an acknowledge to the corresponding one or more second frames in accordance with one or both of OFDMA or MU-MIMO. The resource allocation is to be encoded in one or both the first frame and each of the one or more second frames. The resource allocation in the second frames includes the resource allocation for the corresponding station.

### TECHNICAL FIELD

Embodiments pertain to wireless networks and wireless communications. Some embodiments relate to wireless local area networks (WLANs) and Wi-Fi networks including networks operating in accordance with the IEEE 802.11 family of standards. Some embodiments relate to resource allocation signaling in uplink (UL) frames.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments:

FIG. 2 illustrates a method for resource allocation signaling in uplink (UL) frames in accordance with some embodiments;

FIG. 3 illustrates a frame with a resource allocation element (RAE) dedicated zone (DZ) (RAE-DZ) or RAE in accordance with some embodiments;

FIG. 4 illustrates an RAE-DZ or RAE in accordance with some embodiments;

FIG. 5 illustrates transmission parameter set (TPS) in accordance with some embodiments;

FIG. 6 illustrates a method for resource allocation signaling in frames in accordance with some embodiments;

FIG. 7 illustrates a method for resource allocation signaling in UL frames in accordance with some embodiments;

FIG. 8 illustrates a method for resource allocation signaling in UL frames in accordance with some embodiments;

FIG. 9 illustrates a method for resource allocation signaling in UL frames in accordance with some embodiments;

FIG. 10 illustrates a method for resource allocation signaling in UL frames in accordance with some embodiments;

FIG. 11 illustrates a method for resource allocation signaling in Lit frames in accordance with some embodiments;

FIG. 12 illustrates a method for resource allocation signaling in UL frames in accordance with some embodiments;

FIG. 13 illustrates a method for resource allocation signaling in LA, frames in accordance with some embodiments;

FIG. 14 illustrates a method for resource allocation signaling in UI, frames in accordance with some embodiments;

FIG. 15 illustrates a method for resource allocation signaling in UL frames in accordance with some embodiments; and

FIG. 16 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

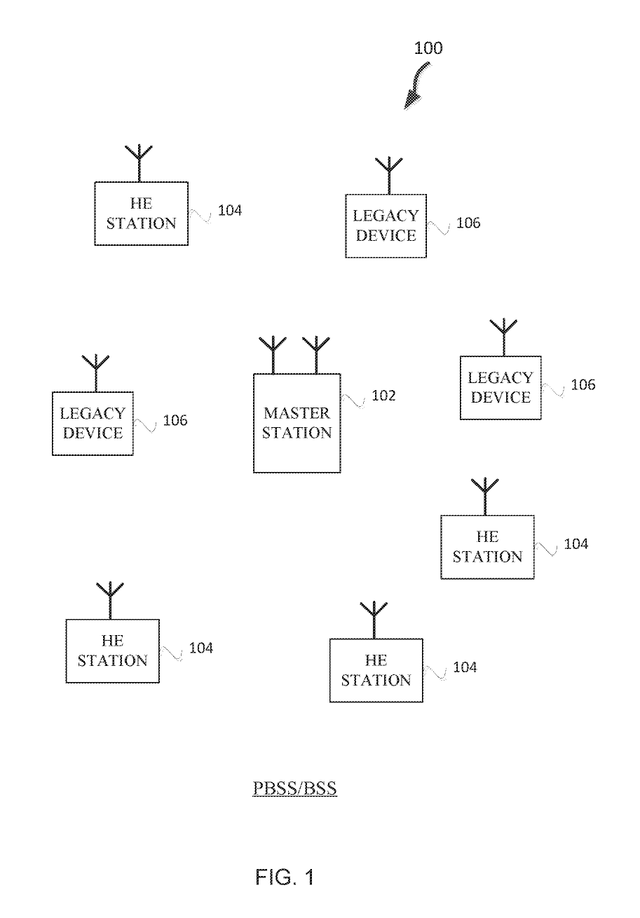

FIG. 1 illustrates a WLAN 100 in accordance with some embodiments. The WLAN may comprise a basis service set (BSS) 100 that may include a master station 102, which may be an AP, a plurality of high-efficiency (HE) wireless (e.g., IEEE 802.11ax) stations 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802:11 protocol may include space-division multiple access (SDMA) and/or multiple-user multiple-input multiple-output (MU-MIMO). There may be more than one master station 102 that is part of a extended service set (ESS). A controller may store information that is common to the more than one master stations 102.

The legacy devices 106 may operate in accordance with one or more of IEEE 802.11 a/b/g/n/ac/ad/af/ah/aj/ay, or another legacy wireless communication standard. The legacy devices 106 may be STAs or IEEE STAs. The HE stations 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations. In some embodiments the HE station 104 may be a “group owner” (GO) for peer-to-peer modes of operation.

The master station 102 may communicate with legacy devices 106 in accordance with legacy IEEE 802.11 communication techniques. In example embodiments, the master station 102 may also be configured to communicate with HE STAs 104 in accordance with legacy IEEE 802.11 communication techniques.

In some embodiments, a HE frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HE frame may be configured for transmitting a number of spatial streams, which may be in accordance with MU-MIMO and, optionally, OFDMA. In other embodiments, the master station 102, HE STA 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may be configured to implement a schedule protocol. A scheduler (not illustrated) of the master station 102 may need to serve multiple requests from multiple entities (e.g., HE station 104, legacy station 106). The master station 102 allocates resources to HE stations 104 and legacy stations 106 by transmitting a trigger frame. The trigger frame includes resource allocation information (e.g., frequency and duration) and air access information (e.g., transmit power, modulation and coding scheme, number of spatial streams) for a specific HE station 104 and/or legacy station 106, or a group of HE stations 104 and/or legacy stations 106. The master station 102 may transmit a HE master-sync transmission, which may be a trigger frame or HE control and schedule transmission, at the beginning of the HE control period. The master-sync transmission can be for a single user (SU) or multiple users (MUs).

The master station 102 may transmit a time duration of the TXOP and sub-channel information. During the HE control period, HE STAs 104 may communicate with the master station 102 in accordance with a non-contention based multiple access technique such as OFDMA or MU-MIMO or both. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a sub-channel smaller than the operating range of the master station 102. During the HE control period, legacy and SU stations refrain from communicating.

In accordance with some embodiments, during the master-sync transmission the HE STAs 104 may contend for the wireless medium with the legacy devices 106 being excluded from contending for the wireless medium during the master-sync transmission. In some embodiments the trigger frame may indicate an uplink (UL) UL-MU-MIMO and/or UL OFDMA control period.

In some embodiments, the multiple-access technique used during the HE control period may be a scheduled OFDMA technique or combination of OFDMA and MU-MIMO, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE control period in accordance with legacy IEEE 802.11 communication techniques, although this is not a requirement.

In example embodiments, the HE device 104 and/or the master station 102 are configured to perform the methods and functions herein described in conjunction with FIGS. 1-16.

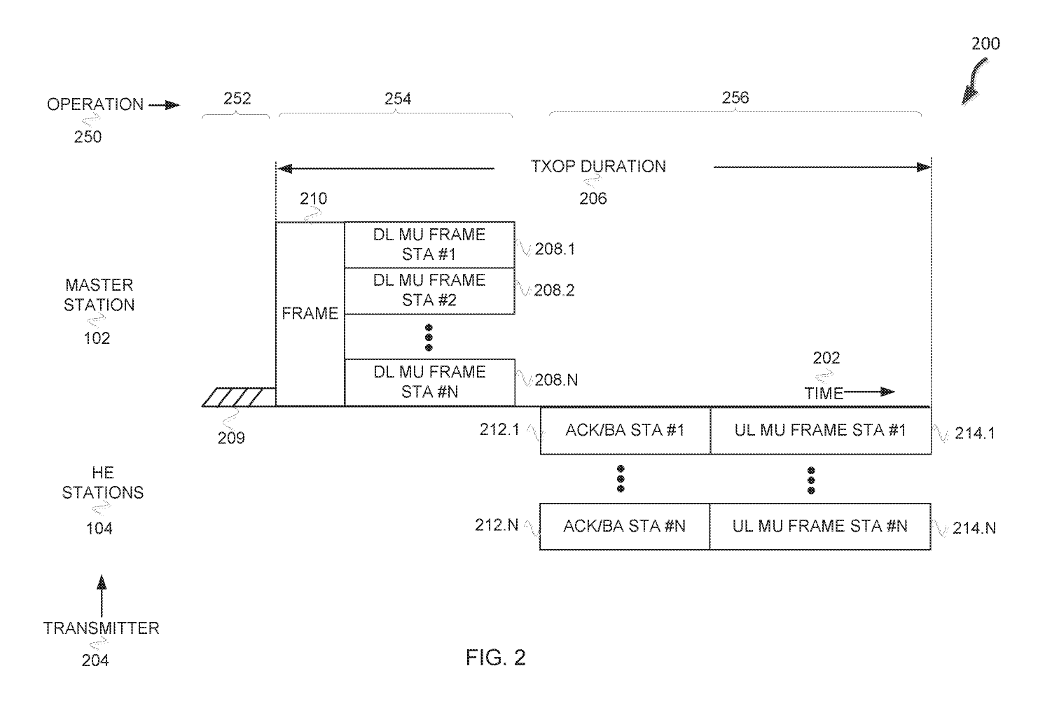

FIG. 2 illustrates a method 200 for resource allocation signaling in uplink (UL) frames in accordance with some embodiments. Illustrated in FIG. 2 is time 202 along a horizontal axis, transmitter 204 along a vertical axis, and operation 250 along the top.

The method 200 may begin at operation 252 with the master station 102 contending for the wireless medium. The master station 102 may determine the wireless medium not busy. The method 200 may continue at operation 254 with the master station 102 transmitting a frame 210 and DL MU frame STA #1-#N 208.1-208.N. The DL MU frame STA #1-#N 208.1-208.N may include an indication of which HE stations 104 the DL MU frame STA#1 is intended for.

The frame 210 may include a first trigger frame (e.g., resource allocation signaling entity and/or resource allocation element), which may provide resource allocations for the UL MU frames STA #1-#N 214.1-214.N.

The frame 210 may include a second trigger frame for the ACK/BA STA #1-#N 12.1-212.N. The frame 210 may include an HE signal B (HE-SIG-B) field that includes the second trigger frame. The frame 210 may be a multicast or broadcast frame. The frame 210 may be an aggregated media access control (MAC) protocol data unit (MPDU)(A-MPDU) comprising a trigger frame or the second trigger frame and may include one or more duplicates of the trigger frame and/or second trigger frame.

The frame 210 may include a duration of a transmission opportunity (TXOP) 206. The method 200 may continue at operation 256 with HE stations 104 transmitting ACK/BA STA #1-#N 212.1-212.N and UL MU frames STA#1-#N 214.1-214.N. The DL MU frame STA#1-#N 208.1-208.N may include the second trigger frame that includes an allocation for UL frames in accordance with OFDMA and/or MU-MIMO. The DL MU frames STA#1-STA#N 208.1-208.N may be A-MPDUs comprising the first trigger frame and/or corresponding portion of the second trigger frame and may include one or more duplicates of the corresponding first or second trigger frame.

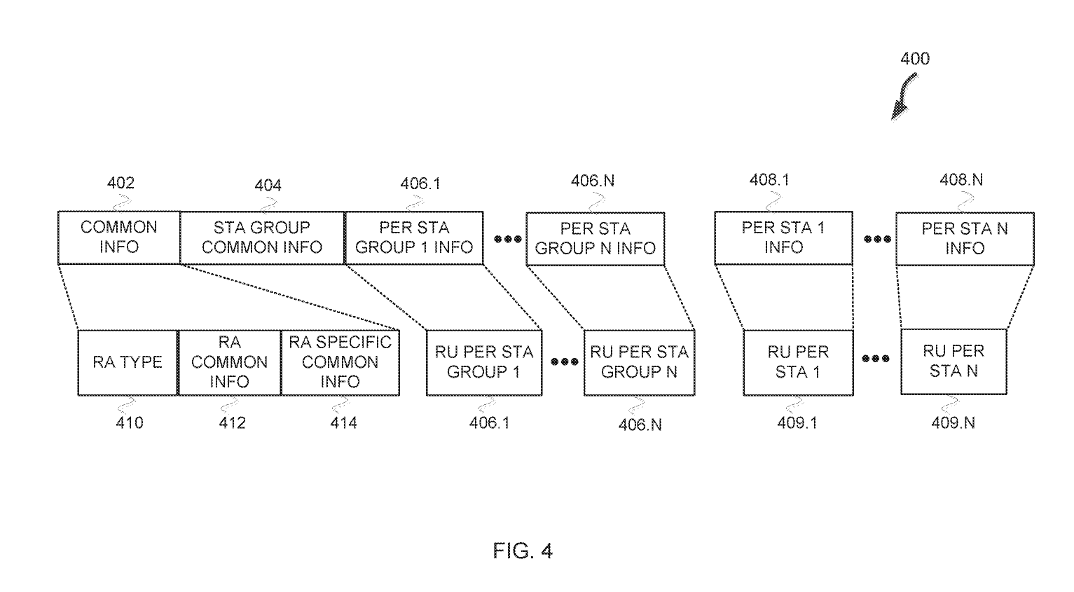

The order of the ACK/BA STA #1-#N 212.1-212.N and UL MU frames STA#1-#N 214.1-214.N may be different. HE stations 104 may transmit only ACK/BA STA #1-#N 212.1-212.N or UL MU frames STA#1-#N 214.1-214.N. In some embodiments the ACK/BA STA #1-#N 212.1-212.N may be a RAE-DZ or RAE 400 (FIG. 4).

In some embodiments, the HE stations 104 are configured to transmit an uplink (UL) multi-user (MU) physical (PHY) layer convergence procedure (PLCP) protocol data unit (PPDU) in accordance with MU-MIMO or OFDMA a duration, e.g., short interframe space (IFS), after receiving the DL MU frame STA#11-#N 208.1-208.N.

In some embodiments the resource allocation for HE stations 104 to acknowledge DL MU frame STA#1-#N 208.1-208.N is contained in the MAC header of the DL MU frame STA#1-#N 208.1-208.N, e.g. MAC protocol data units (MPDUs). The contents of the resource allocation for the HE stations 104 may include UL PPDU length (e.g., 9 bits).

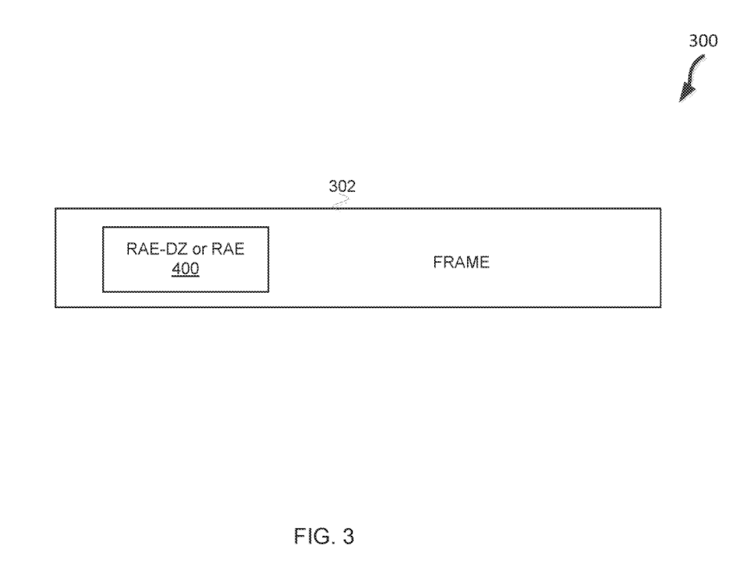

FIG. 3 illustrates a frame 302 with a resource allocation element (RAE) dedicated zone (DZ) (RAE-DZ) or RAE 400 in accordance with some embodiments. The RAE-DZ or RAE 400 (FIG. 4) may be a portion of the frame 302. The frame 302 may be a HE-signal B subfield (HE-SIG-B), trigger frame, uplink (UL) resource allocation information element (RAIE), media access control (MAC) header, or an HE control field. The frame 302 may be another type of frame or a portion of a frame. The RAIE and RAE-DZ may include air access information such as transmit power, modulation and coding scheme, and a number of spatial streams.

The RAE-DZ or RAE 400 may be an area of the frame 302 where one or more RAE-DZ or RAEs 400 may be included. The frame 302 may be a downlink (DL) PPDU. The PPDU may be the frame 302 that needs to be acknowledged. The RAE-DZ or RAE 400 may be included in separate segment of a common UL resource allocation zone, which may be part of a unicast allocation. The RAE-DZ or RAE 400 may include a resource allocation type indication (RATI).

FIG. 4 illustrates an RAE-DZ or RAE 400 in accordance with some embodiments. The RAE 400 may include a RATI that indicates the type and/or format of the RAE or RAE-DZ. The RAE 400 may be a RAE-DZ. The RATI may be field or may be implicit, e.g., using a dedicated multiple acknowledgement control frame (MACF) transmission format. The RAE 400 may provide a resource allocation for one or more multiple acknowledgement control frames (MACFs).

The RAE 400 may include one or more of the following common information 402, station group common information 404, per station group 1 information 406.1 through per station group N information 406.N, and per station 1 information 408.1 through per station N information 408.N.

The common information 402 may be a common part for all stations participating in the defined UL MU transmission and/or UL MACF transmission. The common information 402 may include one or more of the following RA type 410, RA common information 412, and RA specific common information 414. The RA type 410 may be a type of the RA. The RA type 410 may include one or more of the following: single dedicated RAE or RAE-DZ for MACF only, single dedicated RAE or RAE-DZ for MACF and other frames, duplicated RAE or RAE-DZ for MACF only, and duplicated RAE or RAE-DZ for MACF and other frames.

The RA common information 412 may be a common part for all stations participating in the defined UL MU transmission and/or UL MACF transmission. The RA specific common information 414 may be common information for a specific UL MU transmission or UL MACF transmission.

Per station group 1 information 406.1 may include a common part for a group or groups of stations participating in an UL MACF transmission and/or UL MU transmission, and an RU per station group 1 406.1 which may indicate an RU for an UL MACF transmission and/or UL MU transmission.

The per station 1 information 408.1 through per station N information 408.N may each include an RU per station 1 409.1 through RU pre station N 409.N for an UL MACF transmission and/or UL MU transmission.

The RAE 400 may be included in a RAE-DZ 302. The RAE 400 may be included in a separate segment of a common UL resource allocation zone. The RAE-DZ or RAE 400 may include a MACE position indication (MACF-PI). For example, the MACF-PI may be part of the common information 402, station group common information 404, per station group 1-N information 406, or per station 1-N information 406. In some embodiments, the MACF-PI may be one of the following: at the beginning of the UL MPDU, at the end of the UL MPDU, and flexible.

The RAE-DZ or RAE 400 may include a MACF position order indication (MACF-POI). For example, the MACF-POI may be part of the common information 402, station group common information 404, per station group 1-N information 406, or per station 1-N information 406. The MACF-POI will indicate order, e.g., traffic identification order (TID), that the stations are expected to transmit the UL MACF transmission and/or UL MU transmission. The MACF-POI may be one of the following: lower to higher, higher to lower, specific TID order vector, and flexible.

In some embodiments, the RAE-DZ or RAE 400 may include a cyclic redundancy check (CRC) that may be common or dedicated per RAE and/or RAE-DZ. In some embodiments, the RAE-DZ or RAE 400 may be duplicated in time and/or frequency, which may increase the reliability of receiving the RAE-DZ or RAE 400.

The RAE-DZ or RAE 400 may provide increased reliability because the RAE-DZ or RAE 400 may be transmitted at a rate that the station can reliably decode. The RAE-DZ or RAE 400 may increase efficiency because the RAE-DZ or RAE 400 may be transmitted at a higher rate and the BW than the common rate that the TF or RAIE is transmitted.

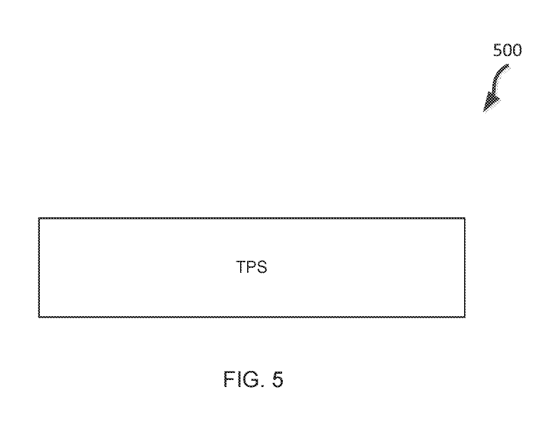

In some embodiments, the RAE-DZ or RAE 400 includes a TPS 500 (FIG. 5). FIG. 5 illustrates transmission parameter set (TPS) 500 in accordance with some embodiments.

The TPS may include one or more of the following. Station identifier (e.g., AID). Station TID identifier. RAE-DZ or RAE 400 type indication RATI. A MACE-PI. A MACF-TOI. Allocation characteristics such as one or more of: allocation unique identifier; allocation method and reference code book; allocation methodology such as allocated number of spatial stream(s) (NSS); UL OFDMA; allocated RU, RU and NSS, etc.; total transmission duration; and, specific allocated bandwidth (BW) and/or RUs and number of space time streams (NSTSs) set. PHY and/or MAC level transmission format such as one or more of: modulation and coding scheme (MCS); transmit power level; number of NSS/antenna chain; contention period; duration limits, margins, and/or range of transmission units for frames such as PPDUs, PSDUs, A-MPDU, and/or MPDU; aggregation format and aggregation limitations, margins, range at MAC unit level for frames such as PPDUs, PSDUs, A-MPDU, and/or MPDU; amount of information limitation at server level, MAC unit level, etc.; and TID limits. Unicast services and quality of service (QoS) for other firms may include one or more of the following: priority, protection level, reliability level, and delay characteristics.

Amount of information limitation at serves level or MAC unit level. Priorities for section of queues and MSDU (e.g., serving priority, serving priority, serving limits for example, TID priority, AC priority, allocation order, priority per TID, priority per AC, allocation order, priority between TIDs and AC, between TID and AC serving limitation (e.g., number of bits, bytes, and duration).

In some embodiments, the station negotiates and/or renegotiates a specific set of TPS parameters or restrictions. The TPS parameters may be determined during association or during traffic stream establishment.

The term RAE-DZ may be used to refer to either a RAE-DZ or a RAE. The term RAE may be used to refer to either a RAE-DZ or a RAE.

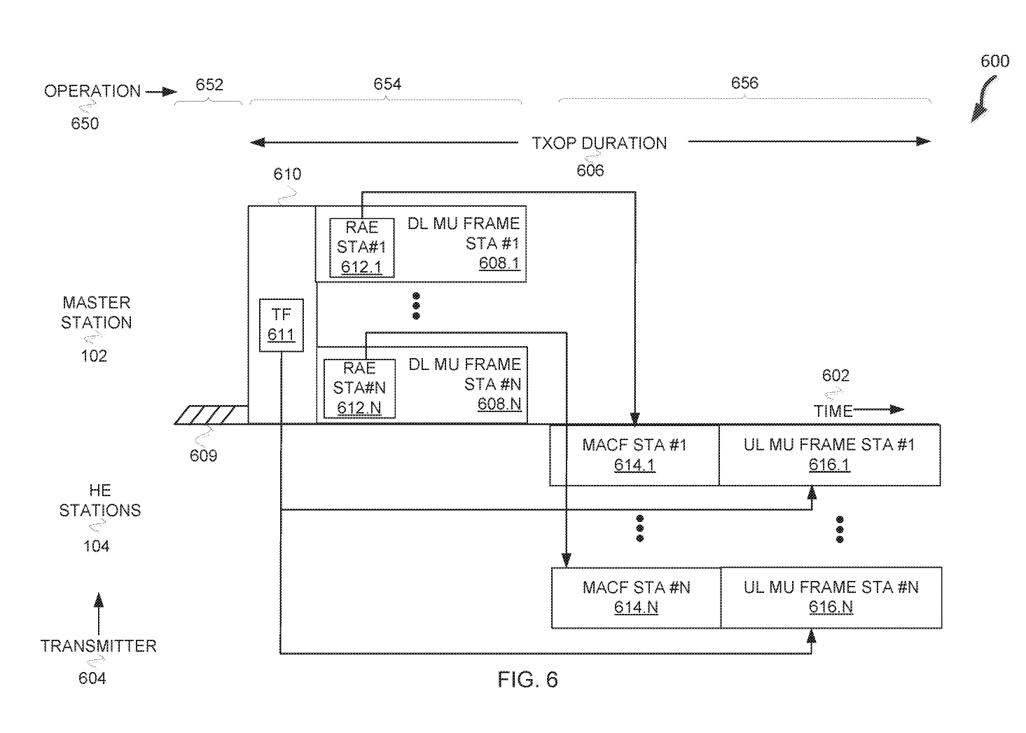

FIG. 6 illustrates a method 600 for resource allocation signaling in UL frames in accordance with some embodiments. Illustrated in FIG. 6 is time 602 along a horizontal axis, transmitter 604 along a vertical axis, and operation 650 along the top.

The method 600 may begin at operation 652 with the master station 102 contending for the wireless medium until the master station 102 determines the wireless medium is not busy.

The method 600 may continue at operation 654 with the master station 102 transmitting frame 610 and DL MU frames STA#1-STA#N 608.1-608.N. The frame 610 includes a trigger frame (TF) 611 with a resource allocation for UL MU frame STA#1-STA#N 616.1-616.N. The frame 610 may include a duration for the TXOP duration 606. The TF 611 may include a RAE or RAE-DZ to indicate the resource allocations for the UL MU frame STA#1-STA#N 616.1-616.N. The frame 610 may be an A-MPDU comprising the trigger frame 611 and may include one or more duplicates of the trigger frame 611.

The DL MU frames STA#1-STA#N 608.1-608.N include a RAE (or RAE-DZ) 612.1-612.#N, which may include a resource allocation for the MACF STA#1-STA#N 616.1-N. The DL MU frames STA#1-STA#N 608.1-608.N may be A-MPDUs comprising the RAE (or RAE-DZ) 612.1-612.#N and may include one or more duplicates of the corresponding RAE (or RAE-DZ) 612.1-612.#N.

The method 600 may continue at operation 656 with the FIE stations 104 transmitting MACF STA#1 614.1-614.N in accordance with the resource allocation indicated in the corresponding RAE STA#1-STA#N 612.1-612.N. The HE stations 104 may also transmit UL MU frame STA#1-STA#N 616.1-616.N in accordance with the corresponding resource allocation indicated in the TF 611. In some embodiments, the time after the DL MU frame STA 608 ends determines when the MACFs STA 614 are transmitted. The MACF STA#1 614.1-614.N may acknowledge the corresponding DL MU frame STA#1-STA#N 608.1-608.N.

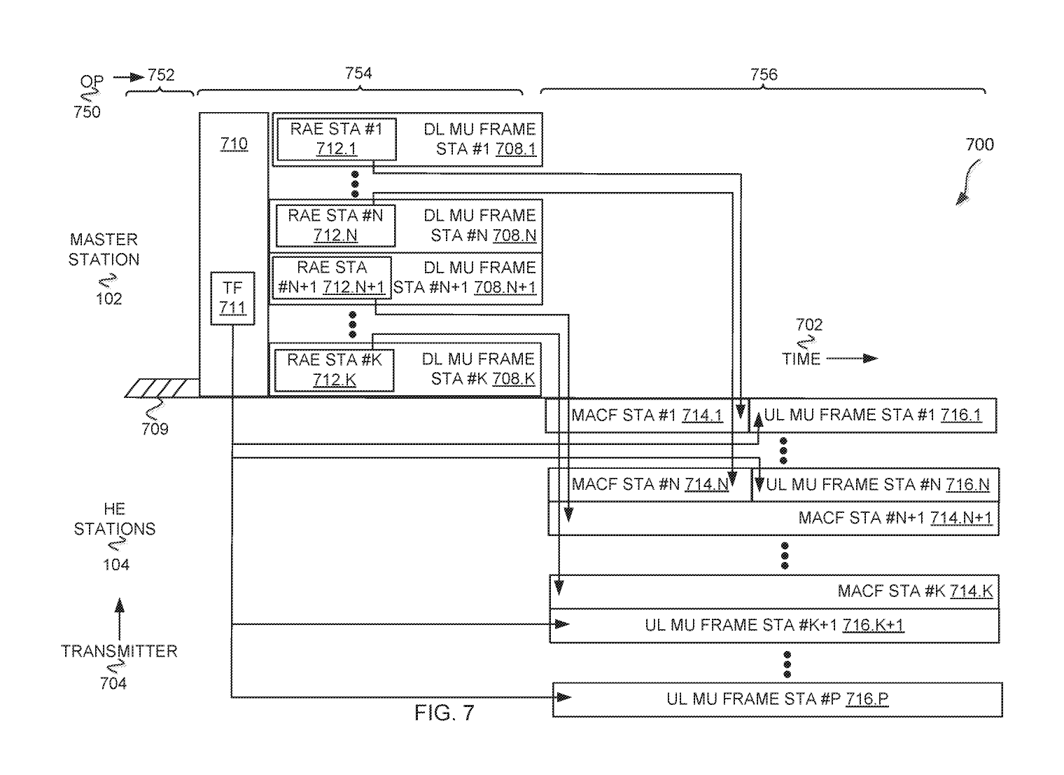

FIG. 7 illustrates a method 700 for resource allocation signaling in UL frames in accordance with some embodiments. Illustrated in FIG. 7 is time 702 along a horizontal axis, transmitter 704 along a vertical axis, and operation 750 along the top.

The method 700 may begin at operation 752 with the master station 102 contending for the wireless medium until the master station 102 determines the wireless medium is not busy.

The method 700 may continue at operation 754 with the master station 102 transmitting frame 710, DL MU frames STA#1 through #N 608.1-608.N, and DL MU frames STA#N+1-STA#K 708.N+1-708.K. The frame 710 includes a trigger frame 711 with a resource allocation for UL MU frame STA#1-STA#N 716.1-716.N, and UL MU frame STA K+1 716.K+1-716.P. The frame 710 may include a duration for the TXOP duration 706. The trigger frame 711 may include a RAE or RAE-DZ for the LT MU resource allocations. The frame 710 may be an A-MPDU comprising the trigger frame 711 and may include one or more duplicates of the trigger frame 711.

The DL MU frames STA#1-STA#N 708.1-708.N and DL MU frames STA#N+1-STA#K 708.N+1-708.K include a RAE (or RAE-DZ) 712.1-712.#N and 712.N+1-712.K, which may include a resource allocation for the MACF STA#1-#N 716.1-716.N and 714.N+1-714.K. The DL MU frames STA#1-STA#N 708.1-708.N and DL MU frames STA#N+1-STA#K 708.N+1-708.K may be A-MPDUs comprising the corresponding RAE (or RAE-DZ) 712.1-712.#N and 712.N+1-712.K and may include one or more duplicates of the corresponding RAE (or RAE-DZ) 712.1-712.#N and 712.N+1-712.K.

The method 700 may continue at operation 756 with the HE stations 104 transmitting MACF STA#1-STA#N 714.1-714.N and MACF STA #N+1 714.N+1-714.K in accordance with the resource allocation indicated in the corresponding RAE STA#1-STA#N 712.1-712.N and RAE STA#N+1-STA#K 712.N+1-712.K. The HE stations 104 may also transmit UL frame STA#1-STA#N 716.1-716.N and UL MU frame STA#K+1-STA #P 716.K+1-716.p in accordance with the corresponding resource allocation indicated in the TF 711. In some embodiments, the time after the DL MU frame STA 708 ends determines when the MACFs STA 714 and UL MU frame STA 716 are transmitted. The MACF STA#1 714.1-714.N and MACF STA#N+1-STA#K 714.N+1-714.K may acknowledge the corresponding DL MU frame STA#1-#N 608.1-608.N and DL MU frame STA#N+1-STA #K 708.N+1-708.K.

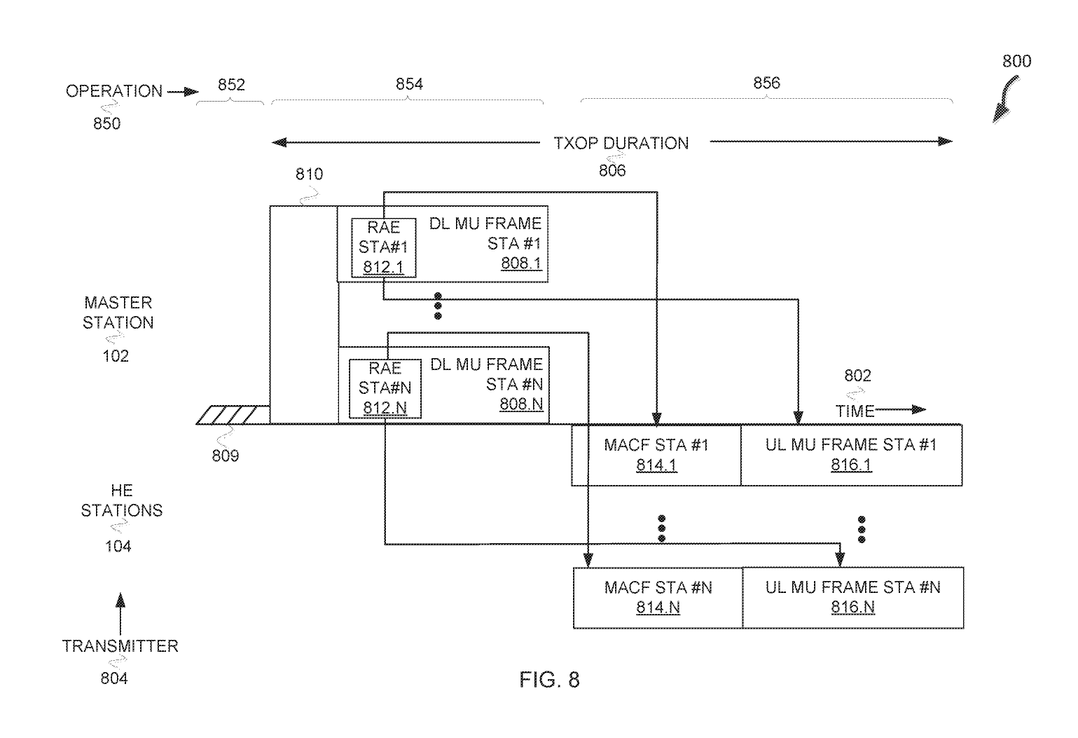

FIG. 8 illustrates a method 800 for resource allocation signaling in UL frames in accordance with some embodiments. Illustrated in FIG. 8 is time 802 along a horizontal axis, transmitter 804 along a vertical axis, and operation 850 along the top.

The method 800 may begin at operation 852 with the master station 102 contending for the wireless medium until the master station 102 determines the wireless medium is not busy.

The method 800 may continue at operation 854 with the master station 102 transmitting frame 810 and DI, MU frames STA#1-STA#N 808.1-808.N. The RAE (or RAE-DZ) 812.1-812.#N includes a resource allocation for UL MU frame STA#1-STA#N 816.1-816.N, and a resource allocation for the MACF STA#1-STA#N 816.1-816.N. The frame 810 may include a duration for the TXOP duration 806.

The method 800 may continue at operation 856 with the HE stations 104 transmitting MACF STA#1 814.1-814.N in accordance with the resource allocation indicated in the corresponding RAE STA#1-STA#N 812.1-812.N. The HE stations 104 may also transmit UL MU frame STA#1-STA#N 816.1-816.N in accordance with the corresponding resource allocation indicated in RAE STA#1-STA#N 812.1-812.N. The DL MU frames STA#1-STA#N 808.1-808.N may be A-MPDUs comprising the RAE (or RAE-DZ) 812.1-812.#N and may include one or more duplicates of the corresponding RAE (or RAE-DZ) 812.1-812.#N.

In some embodiments, the time after the DL MU frame STA 808 ends determines when the MACFs STA 814 are transmitted. The MACF STA#1 814.1-814.N may acknowledge the corresponding DL MU frames STA#1-STA#N 808.1-808.N.

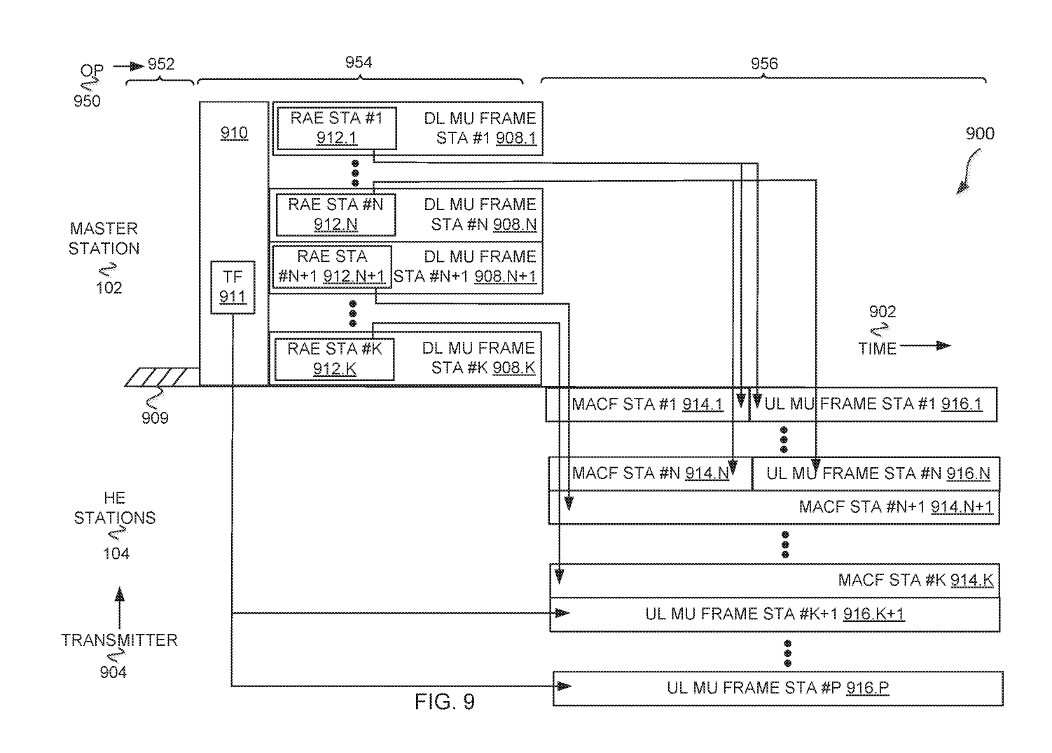

FIG. 9 illustrates a method 900 for resource allocation signaling in UL frames in accordance with some embodiments. Illustrated in FIG. 9 is time 902 along a horizontal axis, transmitter 904 along a vertical axis, and operation 950 along the top.

The method 900 may begin at operation 952 with the master station 102 contending for the wireless medium until the master station 102 determines the wireless medium is not busy.

The method 900 may continue at operation 954 with the master station 102 transmitting frame 910, DL MU frames STA#1-STA#N 908.1-908.N, and DL MU frames STA#N+1-STA#K 908.N+1-908.K. The frame 910 includes a trigger frame 911 with a resource allocation for UL MU frame STA#K+1-STA#P 916.K+1-916.P. The frame 910 may include a duration for the TXOP duration 906. UL MU frame STA#1-STA#N 716.1-716.N, and UL MU frame STA #K+1 716.K+1-716.P. The frame 910 may be an A-MPDU comprising the trigger frame 911 and may include one or more duplicates of the trigger frame 911.

The DL MU frames STA#1-STA#N 908.1-908.N and DL MU frames STA#N+1-STA#K 908.N+1-908.K include a RAE (or RAE-DZ) 912.1-912.#N and 912.N+1-912.K, which may include a resource allocation for the MACF STA#1-#N 916.1-916.N and 914.N+1-914.K. Additionally, RAE (or RAE-DZ) 912.1-912.#N include a resource allocation for UL MU frame STA#1 916.1-916.N.

The DL MU frames STA#1-STA#N 908.1-908.N and DL MU frames STA#N+1-STA#K 908.N+1-908.K may be A-MPDUs comprising the corresponding RAE (or RAE-DZ) 912.1-912.#N and 912.N+1-912.K and may include one or more duplicates of the corresponding RAE (or RAE-DZ) 912.1-912#N and 912.N+1-912.K.

The method 900 may continue at operation 956 with the HE stations 104 transmitting MACF STA#1-STA#N 914.1-914.N and MACF STA #N+1 914.N+1-914.K in accordance with the resource allocation indicated in the corresponding RAE STA#1-STA#N 912.1-912.N and RAE STA#N+1-STA#K 912.N+1-912.K. The HE stations 104 may also transmit UL MU frame STA#1-STA#N 916.1-916.N in accordance with a resource allocation in the corresponding RAE STA#1-STA#N 912.1-912.N.

The HE stations 104 may also transmit UL MU frame STA #K+1-STA #P 916.K+1-916.p in accordance with the corresponding resource allocation indicated in the TF 711. In some embodiments, the time after the DL MU frame STA 908 ends determines when the MACFs STA 914 and UL MU frame STA 916 are transmitted. The MACF STA#1 914.1-914.N and MACF STA#N+1-STA#K 914.N+1-914.K may acknowledge the corresponding DL MU frame STA#1-#N 908.1-908.N and DL MU frame STA#N+1-STA #K 908.N+1-908.K.

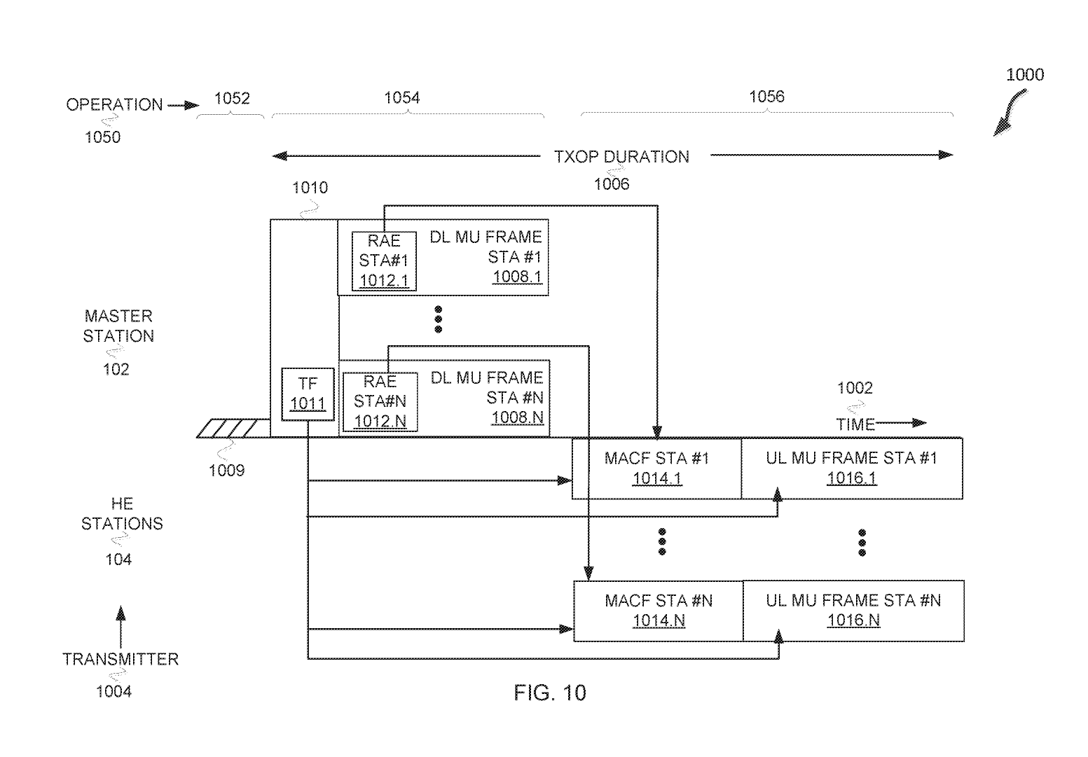

FIG. 10 illustrates a method 1000 for resource allocation signaling in UL frames in accordance with some embodiments. Illustrated in FIG. 10 is time 1002 along a horizontal axis, transmitter 1004 along a vertical axis, and operation 1050 along the top.

The method 1000 may begin at operation 1052 with the master station 102 contending for the wireless medium until the master station 102 determines the wireless medium is not busy.

The method 1000 may continue at operation 1054 with the master station 102 transmitting frame 1010 and DL MU frames STA.41-STA#N 1008.1-1008.N. The frame 1010 includes a TF 1011 with a resource allocation for MACF STA#1-STA#N 1014.1-1014.N, and a resource allocation for UL MU frames STA#1-STA#N 1016.1-1016.N, The frame 1010 may be an A-MPDU comprising the trigger frame 1011 and may include one or more duplicates of the trigger frame 1011.

The frame 1010 may include a duration for the TXOP duration 1006. The TF 1011 may include a RAE or RAE-DZ to indicate the resource allocations for the MAO' STA#1-STA#N 1014.1-1014.N and UL MU frames STA#1-STA#N 1016.1-1016.N.

The DL MU frames STA.#1-STA#N 1008.1-11008.N include a RAE (or RAE-DZ) 1012.1-1012#N, which may include a resource allocation for the MACF STA#1-STA#N 1016.1-N.

The method 1000 may continue at operation 1056 with the HE stations 104 transmitting MACF STA#1 1014.1-1014.N in accordance with the resource allocation indicated in the corresponding RAE STA#1-STA#N 1012.1-1012.N and the TF 1011. The HE stations 104 may be configured to combine the two resource allocations for greater reliability. The DL MU frames STA#1-STA#N 1008.1-1008.N may be A-MPDUs comprising the RAE (or RAE-DZ) 1012.1-1012.#N and may include one or more duplicates of the corresponding RAE (or RAE-DZ) 1012.1-1012.#N.

The HE stations 104 may also transmit Lit MU frame STA#1-STA#N 1016.1-1016.N in accordance with the corresponding resource allocation indicated in the TF 1011. In some embodiments, the time after the DL MU frame STA 1008 ends determines when the MACFs STA 1014 are transmitted. The MACF STA#1 1014.1-1014.N may acknowledge the corresponding DL MU frame STA#1-STA#N 1008.1-1008.N.

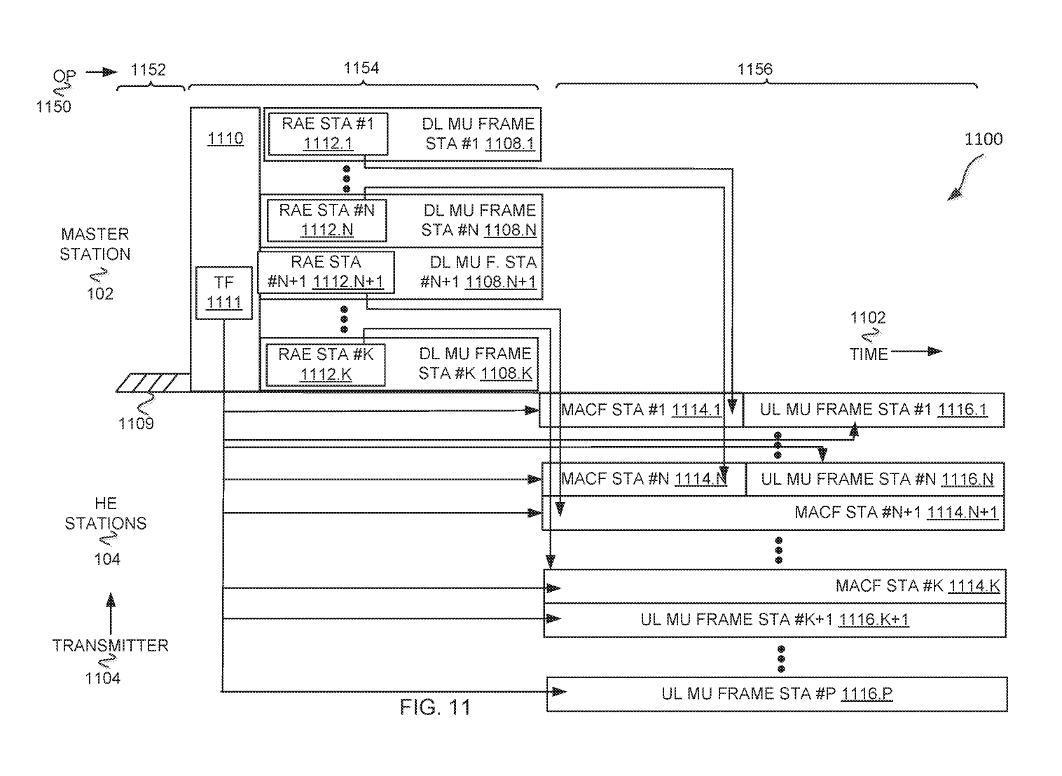

FIG. 11 illustrates a method 1100 for resource allocation signaling in UL frames in accordance with some embodiments. Illustrated in FIG. 11 is time 1102 along a horizontal axis, transmitter 1104 along a vertical axis, and operation 1150 along the top.

The method 1100 may begin at operation 1152 with the master station 102 contending for the wireless medium until the master station 102 determines the wireless medium is not busy.

The method 1100 may continue at operation 1154 with the master station 102 transmitting frame 1110, DL MU frames STA#1-STA#N 1108.1-1108.N, and DL MU frames STA#N+1-STA#K 1108.N+1-1108.K. The frame 1110 includes a trigger frame 1111 with a resource allocation for MACF STA#1-#N 1116.1-1116.N and 1114.N+1 1114.K, and UL MU frame STA#1-STA#N 1116.1-1116.N and STA#K+1-STA#P 1116.K+1-1116.P. The frame 1110 may include a duration for the TXOP duration. The frame 1110 may be an A-MPDU comprising the trigger frame 1111 and may include one or more duplicates of the trigger frame 1111.

The DL MU frames STA#1-STA#N 1108.1-1108.N and DL MU frames STA#N+1-STA#K 1108.N+1-1108.K include a RAE (or RAE-DZ) 1112.1-1112.#N and 1112.N+1-1112.K, which may include a resource allocation for the MACF STA#1-#N 1116.1-1116.N and 1114.N+1 1114.K.

The DL MU frames STA#1-STA#N 1108.1-1108.N and DL MU frames STA#N+1-STA#K 1108.N+1-1108.K may be A-MPDUs comprising the corresponding RAE (or RAE-DZ) 1112.1-1112.#N and 1112.N+1-1112.K and may include one or more duplicates of the corresponding RAE (or RAE-DZ) 1112.1-1112.#N and 1112.N+1-1112.K.

The method 1100 may continue at operation 1156 with the HE stations 104 transmitting MACF STA#1-STA#N 1114.1-1114.N and MACF STA #N+1 1114.N+1-1114.K in accordance with the resource allocation indicated in the corresponding RAE STA#1-STA#N 1112.1-1112.N and RAE STA#N+1-STA#K 1112.N+1-1112.K, and in accordance with the resource allocations indicated in the TF 1111. The HE stations 104 may be configured to combine the two resources allocations for greater reliability.

The HE stations 104 may also transmit UL MU frame STA#1-STA#N 1116.1-1116.N and UL MU frame STA #K+1-STA #P 1116.K+1-1116.p in accordance with the corresponding resource allocation indicated in the TF 1111. In some embodiments, the time after the DL MU frame STA 1108 ends determines when the MACFs STA 1114 and UL MU frame STA 1116 are transmitted. The MACF STA#1 1114.1-1114.N and MACF STA#N+1-STA∩K 1114.N+1-1114.K may acknowledge the corresponding DL MU frame STA#1-#N 1108.1-1108.N and DL MU frame STA#N+1-STA #K 1108.N+1-1108.K.

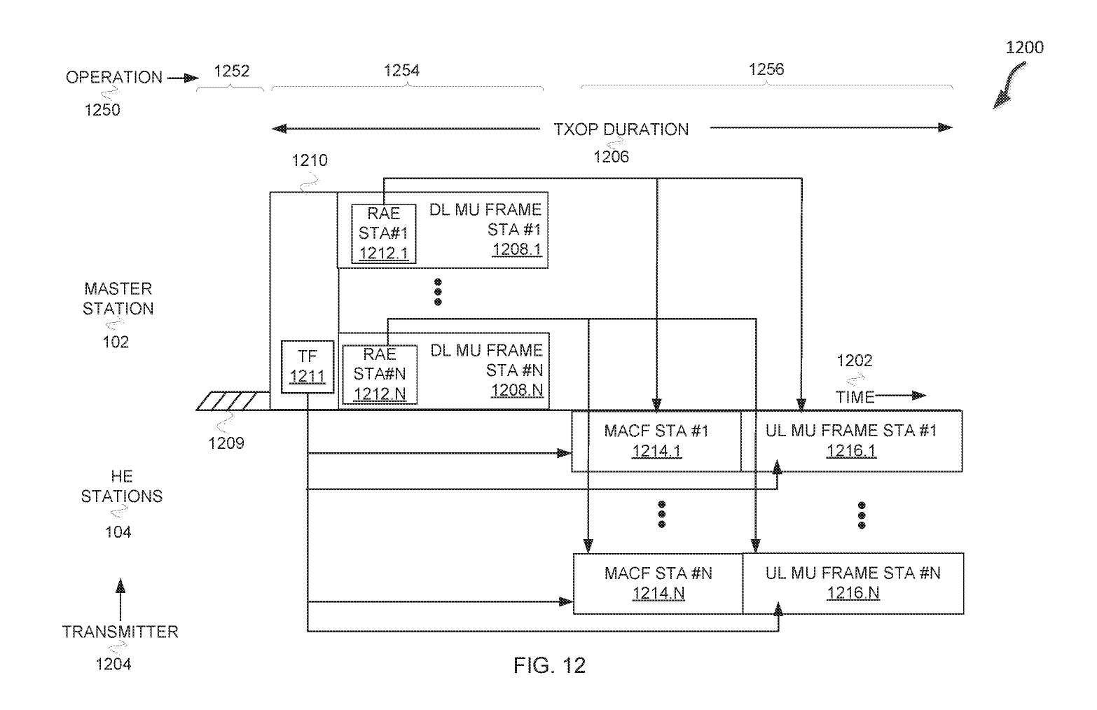

FIG. 12 illustrates a method 1200 for resource allocation signaling in UL frames in accordance with some embodiments. Illustrated in FIG. 12 is time 1202 along a horizontal axis, transmitter 1204 along a vertical axis, and operation 1250 along the top.

The method 1200 may begin at operation 1252 with the master station 102 contending for the wireless medium until the master station 102 determines the wireless medium is not busy.

The method 1200 may continue at operation 1254 with the master station 102 transmitting frame 1210 and DL MU frames STA#1-STA#N 1208.1-1208.N. The frame 1210 includes a TF 1211 with a resource allocation for MACF STA#1-STA#N 1214.1-1214.N, and a resource allocation for UL MU frames STA#1-STA#N 1216.1-1216.N. The frame 1210 may be an A-MPDU comprising the trigger frame 1211 and may include one or more duplicates of the trigger frame 1211.

The frame 1210 may include a duration for the TXOP duration 1206. The TF 1211 may include a RAE or RAE-DZ to indicate the resource allocations for the MACE STA#1-STA#N 1014.1-1014.N and UL MU frames STA#1-STA#N 1016.1-1016.N.

The DL MU frames STA#1-STA#N 1208.1-1208.N include a RAE (or RAE-DZ) 1212.1-1212.#N, which may include a resource allocation for the MACF STA#1-STA#N 1216.1-1216.N, and a resource allocation for the UL MU frames STA#1-STA#N 1216.1-1216.N. The DL MU frames STA#1-STA#N 1208.1-1208.N may be A-MPDUs comprising the RAE (or RAE-DZ) 1212.1-1212.#N and may include one or more duplicates of the corresponding RAE (or RAE-DZ) 1212.1-1212.#N.

The method 1200 may continue at operation 1256 with the HE stations 104 transmitting MACE STA#1 1214.1-1214.N in accordance with the resource allocation indicated in the corresponding RAE STA#1-STA#N 1212.1-1212.N and the TF 1211. The HE stations 104 may be configured to combine the two resource allocations for greater reliability.

The HE stations 104 may also transmit UL MU frame STA#1-STA#N 1216.1-1216.N in accordance with the corresponding resource allocation indicated in the corresponding RAE STA#1-STA#N 1212,1-1212.N and the TF 1211. The HE stations 104 may be configured to combine the two resource allocations for greater reliability.

In some embodiments, the time after the DL MU frame STA 1208 ends determines when the MACFs STA 1214 are transmitted. The MACF STA#1 1214.1-1214.N may acknowledge the corresponding DL MU frame STA#1-STA#N 1208.1-1208.N.

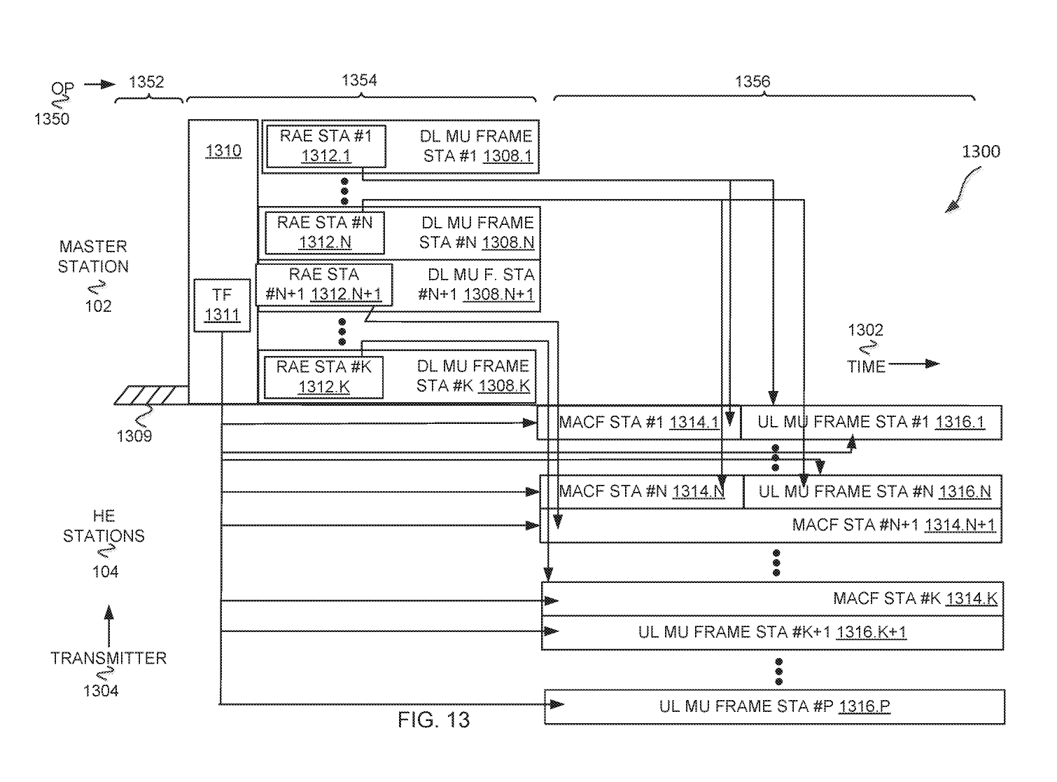

FIG. 13 illustrates a method 1300 for resource allocation signaling in UL frames in accordance with some embodiments. Illustrated in FIG. 13 is time 1302 along a horizontal axis, transmitter 1304 along a vertical axis, and operation 1350 along the top.

The method 1300 may begin at operation 1352 with the master station 102 contending for the wireless medium until the master station 102 determines the wireless medium is not busy.

The method 1300 may continue at operation 1354 with the master station 102 transmitting frame 1310, DL MU frames STA#1-STA#N 1308.1-1308.N, and DL MU frames STA#N+1-STA#K 1308.N+1-1308.K. The frame 1310 includes a trigger frame 1311 with a resource allocation for MACF STA#1-#N 1316.1-1316.N and 1314.N+1 -1314.K, and UL MU frame STA#1-STA#N 1316.1-1316.N and STA#K+1-STA#P 1316.K+1-1316.P. The frame 1310 may include a duration for the TXOP duration, The frame 1310 may be an A-MPDU comprising the trigger frame 1311 and may include one or more duplicates of the trigger frame 1311.

The DL MU frames STA#1-STA#N 1308.1-1308.N and DL MU frames STA#N+1-STA#K 1308.N+1-1308.K include a RAE (or RAE-DZ) 1312.1-1312.#N and 1312.N+1-1312.K, which may include a resource allocation for MACF STA#1.-#N 1316.1-1316.N and 1314.N+1 1314.K, and UL MU frame STA#1-STA#N 1316.1-1316.N and STA#K+1-STA#P 1316.K+1-1316.P.

The method 1300 may continue at operation 1356 with the HE stations 104 transmitting MACF STA#1-STA#N 1314.1-1314.N and MACF STA #N+1 1314.N+1-1314.K in accordance with the resource allocation indicated in the corresponding RAE STA#1-STA#N 1312.1-1312.N and RAE STA#N+1-STA#K 131.2.N+1-1312.K, and in accordance with the resource allocations indicated in the TF 1311. The HE stations 104 may be configured to combine the two resources allocations for greater reliability.

The DL MU frames STA#1-STA#N 1308.1-1308.N and DL MU frames STA#N+1-STA#K 1308.N+1-1308.K may be A-MPDUs comprising the corresponding RAE (or RAE-DZ) 1312.1-1312.#N and 1312.N+1-1312.K and may include one or more duplicates of the corresponding RAE (or RAE-DZ) 1312.1-1312.#N and 1312.N+1-1312.K.

The HE stations 104 may also transmit UL MU frame STA#1-STA#N 1316.1-1316.N and UL MU frame STA #K+1-STA #P 1316.K+1-1316.p in accordance with the corresponding resource allocation indicated in the corresponding RAE STA#1-STA#N 1312.1-1312.N and RAE STA#N+1-STA#K 1312.N+1-1312.K, and in accordance with the resource allocations indicated in the TF 1311. In some embodiments, the time after the DL MU frame STA 1308 ends determines when the MACFs STA 1314 and UL MU frame STA 1316 are transmitted. The MACF STA#1 1314.1-1314.N and MACF STA#N+1-STA#K 1314.N+1-1314.K may acknowledge the corresponding DL MU frame STA#1-#N 1308.1-1308.N and DL MU frame STA#N+1-STA #K 1308.N+1-1308.K.

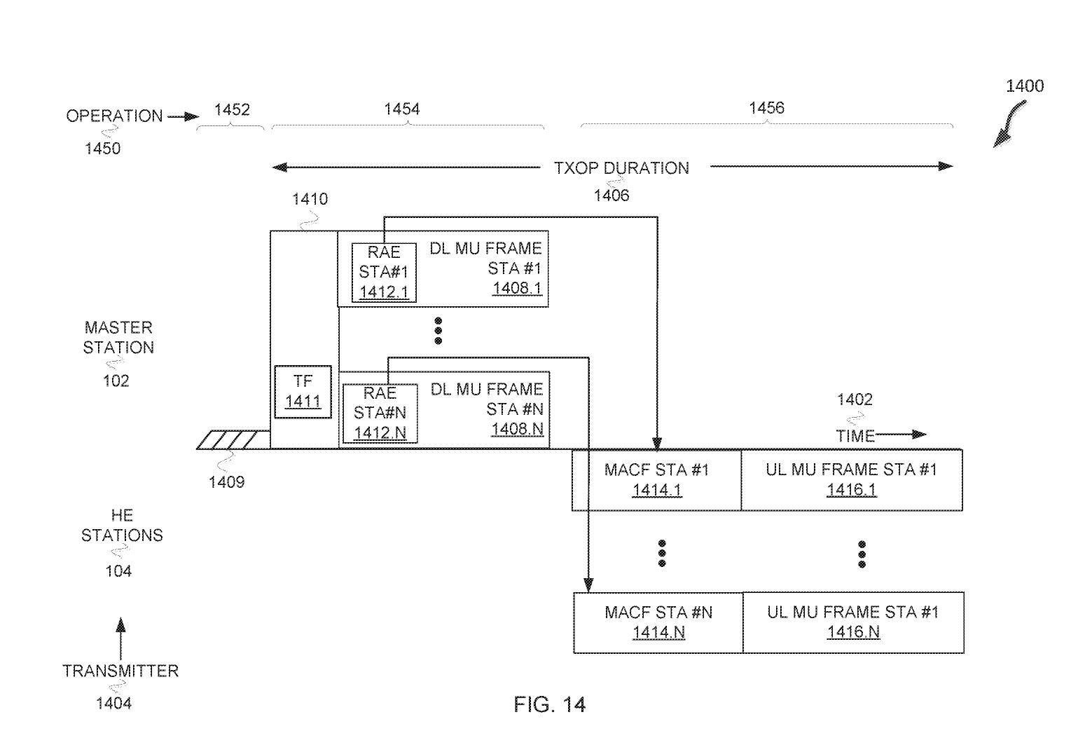

FIG. 14 illustrates a method 1400 for resource allocation signaling in UL frames in accordance with some embodiments. Illustrated in FIG. 14 is time 1402 along a horizontal axis, transmitter 1404 along a vertical axis, and operation 1450 along the top.

The method 1400 may begin at operation 1452 with the master station 102 contending for the wireless medium until the master station 102 determines the wireless medium is not busy.

The method 1400 may continue at operation 1454 with the master station 102 transmitting frame 1410 and DL MU frames STA#1-STA#N 1408.1-1408.N. The frame 1410 includes a TF 1411 which may include a resource allocation for one or more of the following: MACF STA#1-STA#N 1414.1-1414.N, and a resource allocation for UL MU frames STA#1-STA#N 1416.1-1416.N. The frame 1410 may be an A-MPDU comprising the trigger frame 1411 and may include one or more duplicates of the trigger frame 1411.

The frame 1410 may include a duration for the TXOP duration 1406. The TF 1411 may include a RAE or RAE-DZ to indicate the resource allocations for the MACE STA#1-STA#N 1414.1-1414.N and UL MU frames STA#1-STA#N 1416.1-1416.N. The DL MU frames STA#1-STA#N 1408.1-1408.N may be A-MPDUs comprising the RAE (or RAE-DZ) 1412.1-1412.#N and may include one or more duplicates of the corresponding RAE (or RAE-DZ) 1412.1-1412.#N.

The DL MU frames STA#1 -STA#N 1408.1-1408.N include a RAE (or RAE-DZ) 1412.1-1412.#N, Which may include a resource allocation for the MACF STA#1-STA#N 1416.1-1416.N, and, in some embodiments, a resource allocation for the UL MU frames STA.41-STA#N 1416.1-1416.N.

The method 1400 may continue at operation 1456 with the HE stations 104 transmitting MACF STA#1 1414.1-1414.N in accordance with the resource allocation indicated in the corresponding RAE STA#1-STA#N 1412.1-1412.N and the TF 1411. The HE stations 104 may be configured to combine the two resource allocations for greater reliability. As illustrated the RAE STA#1 1412.1 RAE STA#N 1412.N indicate (e.g., position indicator equal to beginning) that the position of the MACFs STA#1-STA#N 1414.1-1414.n need to be transmitted the beginning of operation 1456, or at a beginning a first UL MPDU the HE stations 104 transmit. The frame 1410 may be an A-MPDU comprising the trigger frame 1411 and may include one or more duplicates of the trigger frame 1411.

The HE stations 104 may also transmit Lit MU frame STA#1-STA#N 1416.1-1416.N in accordance with a corresponding resource allocation that may be indicated in the corresponding RAE STA#1-STA#N 1412.1-1412,N or in the TF 1411. The HE stations 104 may be configured to combine the two resource allocations for greater reliability.

In some embodiments, the time after the DL MU frame STA 1408 ends determines when the MACFs STA 1414 are transmitted. The MACF STA#11 1414.1-1414.N may acknowledge the corresponding DL NW frame STA#1-STA#N 1408.1-1408.N.

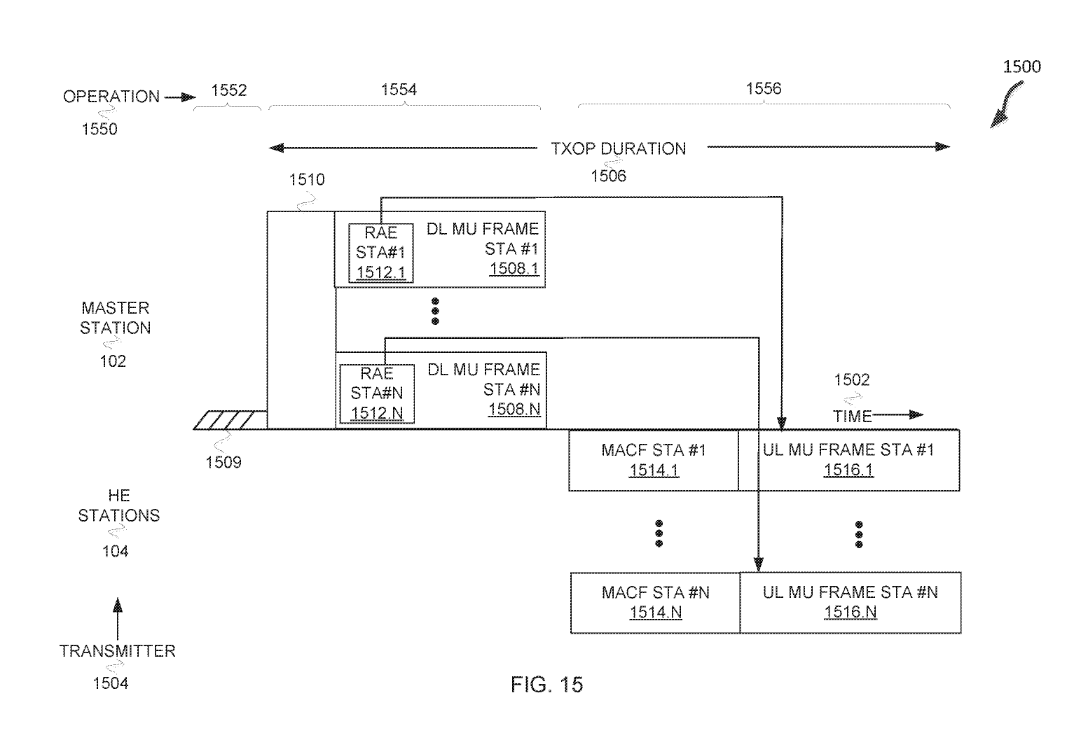

FIG. 15 illustrates a method 1500 for resource allocation signaling in UL frames in accordance with some embodiments. Illustrated in FIG. 15 is time 1502 along a horizontal axis, transmitter 1504 along a vertical axis, and operation 1550 along the top.

The method 1500 may begin at operation 1552 with the master station 102 contending for the wireless medium until the master station 102 determines the wireless medium is not busy.

The method 1500 may continue at operation 1554 with the master station 102 transmitting frame 1510 and DL MU frames STA#1-STA#N 1508.1-1508.N. The frame 1510 includes a TF 1511 which may include a resource allocation for one or more of the following: MACF STA#1-STA#N 1514.1-1514.N, and a resource allocation for UL MU frames STA#1-STA#N 1516.1-1516.N. The frame 1510 may be an A-MPDU comprising the trigger frame 1511 and may include one or more duplicates of the trigger frame 1511.

The frame 1510 may include a duration for the TXOP duration 1506, The IT 1511 may include a RAE or RAE-DZ to indicate the resource allocations for the MACF STA#1-STA#N 1514.1-1514.N and UL MU frames STA#1-STA#N 1516.1-1516.N, The DL MU frames STA#1-STA#N 1508.1-1508.N may be A-MPDUs comprising the RAE (or RAE-DZ) 1512.1-1512.#N and may include one or more duplicates of the corresponding RAE (or RAE-DZ) 1512.1-1512.#N.

The DL MU frames STA#1-STA#N 1508.1-1508.N include a RAE (or RAE-DZ) 1512.1-1512.#N, which may include a resource allocation for the MACF STA#1-STA#N 1516.1-1516.N, and, in some embodiments, a resource allocation for the LT MU frames STA#1-STA#N 1516.1-1516.N.

The method 1500 may continue at operation 1556 with the HE stations 104 transmitting MACF STA#1 1514.1-1514.N in accordance with the resource allocation indicated in the corresponding RAE STA#1-STA#N 1512.1-1512.N and the TF 1511. The HE stations 104 may be configured to combine the two resource allocations for greater reliability. As illustrated the RAE STA#1 1512.1 RAE STA#N 1512.N indicate (e.g., position indicator equal to end) that the position of the MACFs STA#1 STA#N 1514.1-1514.n need to be transmitted at the end of operation 1556, or at a beginning a first LT MPDU the HE stations 104 transmit.

The HE stations 104 may also transmit UL MU frame STA#1-STA#N 1516.1-1516.N in accordance with a corresponding resource allocation that may be indicated in the corresponding RAE STA#1-STA#N 1512.1-1512.N or in the TF 1511. The HE stations 104 may be configured to combine the two resource allocations for greater reliability.

In some embodiments, the time after the DL MU frame STA 1508 ends determines when the MACFs STA 1514 are transmitted. The MACF STA#1 1514.1-1514.N may acknowledge the corresponding DL MU frame STA#1-STA#N 1508.1-1508.N.

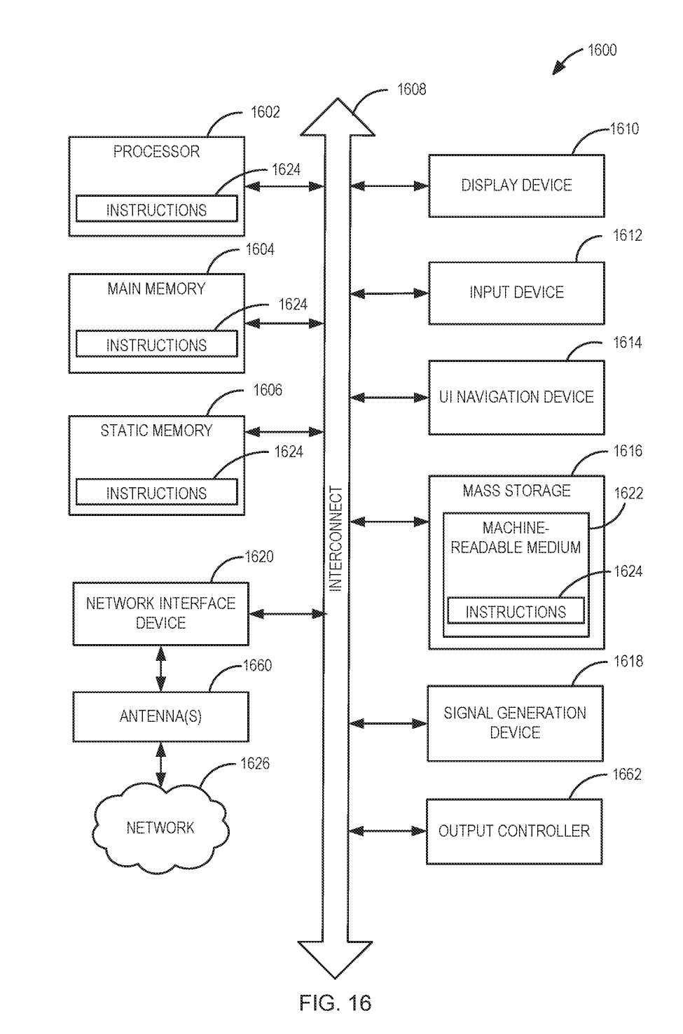

FIG. 16 illustrates a block diagram of an example machine 1600 upon which any one or more of the techniques (e.g., methodologies) discussed herein may perform. In alternative embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in peer-to-peer (P2P) (or other distributed) network environment. The machine 1600 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1600 may include a hardware processor 1602 (e.g., a central processing unit (CPU), a graphics processing unit (GM), a hardware processor core, or any combination thereof), a main memory 1604 and a static memory 1606, some or all of which may communicate with each other via an interlink (e.g., bus) 1608. The machine 1600 may further include a display unit 1610, an alphanumeric input device 1612 (e.g., a keyboard), and a user interface (IA) navigation device 1614 (e.g., a mouse). In an example, the display unit 1610, input device 1612 and UI navigation device 1614 may be a touch screen display. The machine 1600 may additionally include a storage device (e.g., drive unit) 1616, a signal generation device 1618 (e.g., a speaker), a network interface device 1620, and one or more sensors 1621, such as a global positioning system (GPS) sensor, compass, accelerometer, or other sensor. The machine 1600 may include an output controller 1628, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 1602 and/or instructions 1624 may comprise processing circuitry.

The storage device 1616 may include a machine readable medium 1622 on which is stored one or more sets of data structures or instructions 1624 (e.g., software) embodying or utilized by any one or more of the techniques or functions described herein. The instructions 1624 may also reside, completely or at least partially, within the main memory 1604, within static memory 1606, or within the hardware processor 1602 during execution thereof by the machine 1600. In an example, one or any combination of the hardware processor 1602, the main memory 1604, the static memory 1606, or the storage device 1616 may constitute machine readable media.

While the machine readable medium 1622 is illustrated as a single medium, the term “machine readable medium” may include a single medium or multiple media (e.g., a centralized or distributed database, and/or associated caches and servers) configured to store the one or more instructions 1624.

The term “machine readable medium” may include any medium that is capable of storing, encoding, or carrying instructions for execution by the machine 1600 and that cause the machine 1600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable

Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1624 may further be transmitted or received over a. communications network 1626 using a transmission medium via the network interface device 1620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1620 may include one or more physical jacks (e.g., Ethernet, coaxial, or phone jacks) or one or more antennas to connect to the communications network 1626. In an example, the network interface device 1620 may include a plurality of antennas to wirelessly communicate using at least one of single-input multiple-output (SIMO), multiple-input multiple-output (MIMO), or multiple-input single-output (MISO) techniques, In some examples, the network interface device 1620 may wirelessly communicate using Multiple User MIMO techniques. The term “transmission medium” shall be taken to include any intangible medium that is capable of storing, encoding or carrying instructions for execution by the machine 1600, and includes digital or analog communications signals or other intangible medium to facilitate communication of such software.

The following examples pertain to further embodiments. Specifics in the examples may be used in one or more embodiments.

Example 1 is an apparatus of an access point comprising memory and processing circuitry coupled to the memory. The processing circuitry may be configured to: encode a first frame for a broadcast or multi cast transmission, and encode one or more second frames for one or both of downlink (DL) orthogonal frequency division multiple-access (OFDMA) or multiple user multiple-input multiple-output (MU-MIMO), where the one or more second frames comprise data for a plurality of stations, and where the one or more second frames are unicast frames. The processing circuitry may be further configured to: encode a resource allocation for each of the plurality of stations to transmit one or more third frames comprising an acknowledge to the corresponding one or more second frames in accordance with one or both of OFDMA or MU-MIMO, where the resource allocation is to be encoded in one or both the first frame and each of the one or more second frames, and where the resource allocation in each of the one or more second frames comprises the resource allocation for the corresponding station of the plurality of stations, and where the resource allocation comprises one or both of an OFDMA resource allocation or a MU-MIMO resource allocation. The processing circuitry may be further configured to: configure the access point to transmit the first frame, configure the access point to transmit the second frame, and decode the one or more third frames comprising the acknowledgements from the plurality stations, where the acknowledgements are of the one or more second frames, and where the acknowledges are received in accordance with the resource allocation.

In Example 2, the subject matter of Example 1 can optionally include where the resource allocation is encoded in either the first frame or the one or more second frames.

In Example 3, the subject matter of Example 2 can optionally include where the first frame or the second frame comprises an aggregated media access control (MAC) protocol data unit (MPDU)(A-MPDU) comprising the resource allocation and one or more duplicated resource allocations encoded in the A-MPDU.

In Example 4, the subject matter of any of Examples 1-3 can optionally include where the processing circuitry is further configured to: encode a second resource allocation for one or more of the plurality of stations to transmit one or more fourth frames in accordance with one or both of uplink (UL) OFDMA or MU-MIMO, where the second resource al location is to be encoded in one or both of the first frame and one or more of the one or more second frames, where the second resource allocation in one or more of the one or more second frames comprises the second resource allocation for the corresponding station of the one or more stations of the plurality of stations.

In Example 5, the subject matter of Example 4 can optionally include where the processing circuitry is further configured to: encode a third resource al location for one or more second stations to transmit one or more fifth frames in accordance with one or both of uplink (UL) OFDMA or MU-MIMO, where the third resource allocation is to be encoded in the first frame.

In Example 6, the subject matter of Example 5 can optionally include where the first frame comprises a duration for a transmission opportunity and wherein the first frame, the one or more second frames, the one or more third frames, the one or more fourth frames, and the one or more fifth frames are to be transmitted in or within the transmission opportunity.

In Example 7, the subject matter of any of Examples 1-6 can optionally include where the first frame has a first bandwidth and the one or more second frames are transmitted on sub-channels of the first bandwidth.

In Example 8, the subject matter of any of Examples 1-7 can optionally include where the resource allocation is for a multiple acknowledgment control frame (MACF), and where the resource allocation comprises one or more of the following group of air access parameters: modulation and coding scheme (MCS), number of spatial streams, and transmit power.

In Example 9, the subject matter of any of Examples 1-8 can optionally include where the resource allocation indicates one of the following group: a single dedicated resource allocation element (RAE) or RAE dedicated zone (RAE-DZ) for MACF only, single dedicated RAE or RAE-DZ for MACF and UL frame, duplicated RAE or RAE-DZ for MACF only, and duplicated RAE or RAE-DZ for MACF and UL frame.

In Example 10, the subject matter of any of Examples 1-9 can optionally include where the resource allocation for each of the plurality of stations to transmit the one or more third frames is indicated by one or more groups of stations of the plurality of stations.

In Example 11, the subject matter of any of Examples 1-10 can optionally include where the resource allocation is encoded in both the first frame and each of the one or more second frames, and wherein a transmission parameter set is encoded in only one of the first frame or each of the one or more second frames.

In Example 12, the subject matter of any of Examples 1-11 can optionally include where the access point and each of the plurality of stations is one from the following group: an Institute of Electrical and Electronic Engineers (IEEE) 802.11ax access point, an IEEE 802.11ax station, an IEEE 802.11 station, and an IEEE 802.11 access point.

In Example 13, the subject matter of any of Examples 1-12 can optionally include where the first frame comprises a trigger frame with a downlink resource allocation for the plurality of stations for the one or more second frames for one or both of DL OFDMA or MU-MIMO.

In Example 14, the subject matter of Example 13 can optionally include transceiver circuitry coupled to the processing circuitry, and, one or more antennas coupled to the transceiver circuitry.

Example 15 is a non-transitory computer-readable storage medium that stores instructions for execution by one or more processors. The instructions to configure the one or more processors to cause an access point to: encode a first frame for a broadcast or multicast transmission, and encode one or more second frames for one or both of downlink (DL) multi-user multiple-input multiple-output (MU-MIMO) or DL orthogonal frequency division multiple-access (OFDMA), where the one or more second frames comprise data for a plurality of stations, and where the one or more second frames are unicast frames. The instructions to further configure the one or more processors to cause an access point to: encode a resource allocation for each of the plurality of stations to transmit one or more third frames comprising an acknowledge to the corresponding one or more second frames in accordance with one or both of OFDMA or multiple user multiple-input multiple-output (MU-MIMO), where the resource allocation is to be encoded in one or both the first frame and each of the one or more second frames, where the resource allocation in each of the one or more second frames comprises the resource allocation for the corresponding station of the plurality of stations. The instructions to further configure the one or more processors to cause an access point to: configure the access point to transmit the first frame, configure the access point to transmit the second frame, and decode acknowledgements from the plurality stations, wherein the acknowledgements are of the one or more second frames, and where the acknowledges are received in accordance with the resource allocation.

In Example 16, the subject matter of Example 16 can optionally include where the instructions further configure the one or more processors to cause the access point to: encode a second resource allocation for one or more of the plurality of stations to transmit one or more fourth frames in accordance with one or both of uplink (UL) OFDMA or MU-MIMO, where the second resource allocation is to be encoded in one or both of the first frame and one or more of the one or more second frames, where the second resource allocation in one or more of the one or more second frames comprises the second resource allocation for the corresponding station of the one or more stations of the plurality of stations.

In Example 17, the subject matter of Examples 15-16 can optionally include where the instructions further configure the one or more processors to cause the access point to: encode a third resource allocation for one or more second stations to transmit one or more fifth frames in accordance with one or both of uplink (UL) OFDMA or MU-MIMO, where the third resource allocation is to be encoded in the first frame.

In Example 18, the subject matter of any of Examples 15-17 can optionally include where the first frame has a first bandwidth and the one or snore second frames are transmitted on sub-channels of the first bandwidth.

In Example 19, the subject matter of any of Examples 15-18 can optionally include where the resource allocation is for a multiple acknowledgment control frame (MACF).

Example 20 is a method performed by an access point. The method including encoding a first frame for a broadcast or multicast transmission, and encoding one or more second frames for one or both of downlink (DL) multi-user multiple-input multiple-output (MU-MIMO) or DL orthogonal frequency division multiple-access (OFDMA), where the one or more second frames comprise data for a plurality of stations, and where the one or more second frames are unicast frames. The method may further include encoding a resource allocation for each of the plurality of stations to transmit one or more third frames comprising an acknowledge to the corresponding one or more second frames in accordance with one or both of OFDMA or multiple user multiple-input multiple-output (MU-MIMO), where the resource allocation is to be encoded in one or both the first frame and each of the one or more second frames, where the resource allocation in each of the one or more second frames comprises the resource allocation for the corresponding station of the plurality of stations. The method may further include configuring the access point to transmit the first frame, configuring the access point to transmit the second frame, and decoding acknowledgements from the plurality stations, where the acknowledgements are of the one or more second frames, and where the acknowledges are received in accordance with the resource allocation.

In Example 21, the subject matter of Example 21 can optionally include encoding a second resource allocation for one or more of the plurality of stations to transmit one or more fourth frames in accordance with one or both of uplink (UL) OFDMA or MU-MIMO, where the second resource allocation is to be encoded in one or both of the first frame and one or more of the one or more second frames, where the second resource allocation in one or more of the one or more second frames comprises the second resource allocation for the corresponding station of the one or more stations of the plurality of stations.

Example 22 is an apparatus of a station comprising memory; and processing circuitry coupled to the memory. The processing circuitry may be configured to: decode a first frame, where the first frame is a broadcast or multicast transmission, decode a second frame for downlink (DL) orthogonal frequency division multiple-access (OFDMA), where the second frame comprises data fur the station, and decode a resource allocation for the station to transmit a third frame comprising an acknowledge to the second frames in accordance with one or both of OFDMA or multiple user multiple-input multiple-output (MU-MIMO), where the resource allocation is encoded in one or both of the first frame and the second frame. The processing circuitry may be further configured to encode an acknowledgment of the second frame, and configure the station to transmit the acknowledgement in accordance with the resource allocation.

In Example 23, the subject matter of Example 22 can optionally include where the processing circuitry is further configured to: decode a second resource allocation for the station to transmit a fourth frame in accordance with one or both of uplink (UL) OFDMA or MU-MIMO, where the second resource allocation is to be encoded in one or both of the first frame and the second frame.

In Example 24, the subject matter of Examples 22 or 23 can optionally include where the acknowledgement is a multiple acknowledgment control frame (MACF).

In Example 25, the subject matter of any of Examples 22-24 can optionally include transceiver circuitry coupled to the processing circuitry; and, one or more antennas coupled to the transceiver circuitry.

Example 26 is an apparatus of an access point, the apparatus including: means fur encoding a first frame for a broadcast or multicast transmission, and means for encoding one or more second frames for one or both of downlink (DL) orthogonal frequency division multiple-access (OFDMA) or multiple user multiple-input multiple-output (MU-MIMO), where the one or more second frames comprise data for a plurality of stations, and where the one or more second frames are unicast frames. The apparatus may further include means for encoding a resource allocation for each of the plurality of stations to transmit one or more third frames comprising an acknowledge to the corresponding one or more second frames in accordance with one or both of OFDMA or MU-MIMO, where the resource allocation is to be encoded in one or both the first frame and each of the one or more second frames, where the resource allocation in each of the one or more second frames comprises the resource allocation for the corresponding station of the plurality of stations, The apparatus may further include means for configuring the access point to transmit the first frame, means for configuring the access point to transmit the second frame, and means for decoding the one or more third frames comprising the acknowledgements from the plurality stations, where the acknowledgements are of the one or more second frames, and where the acknowledges are received in accordance with the resource allocation.

In Example 27, the subject matter of Example 26 can optionally include where the resource allocation is encoded in either the first frame or the one or more second frames.

In Example 28, the subject matter of Example 27 can optionally include where the first frame or the second frame comprises an aggregated media access control (MAC) protocol data unit (MPDU)(A-MPDU) comprising the resource al location and one or more duplicated resource al locations encoded in the A-MPDU.

In Example 29, the subject matter of any of Examples 26-28 can optionally include means for encoding a second resource allocation for one or more of the plurality f stations to transmit one or more fourth frames in accordance with one or both of uplink (UL) OFDMA or MU-MIMO, where the second resource allocation is to be encoded in one or both of the first frame and one or more of the one or more second frames, where the second resource allocation in one or more of the one or more second frames comprises the second resource allocation for the corresponding station of the one or more stations of the plurality of stations.

In Example 30, the subject matter of Example 30 can optionally include means for encoding a third resource allocation for one or more second stations to transmit one or more fifth frames in accordance with one or both of uplink (UL) OFDMA or MU-MIMO, wherein the third resource allocation is to be encoded in the first frame.

In Example 31, the subject matter of Example 30 can optionally include where the first frame comprises a duration for a transmission opportunity and wherein the first frame, the one or more second frames, the one or more third frames, the one or more fourth frames, and the one or more fifth frames are to be transmitted in or within the transmission opportunity.

In Example 32, the subject matter of any of Examples 26-31 can optionally include where the first frame has a first bandwidth and the one or more second frames are transmitted on sub-channels of the first bandwidth.

In Example 33, the subject matter of any of Examples 26-32 can optionally include where the resource allocation is for a multiple acknowledgment control frame (MACF), and wherein the resource allocation comprises one or more of the following group of air access parameters: modulation and coding scheme (MCS), number of spatial streams, and transmit power.

In Example 34, the subject matter of any of Examples 26-33 can optionally include where the resource allocation indicates one of the following group: a single dedicated resource allocation element (RAE) or RAE dedicated zone (RAE-DZ) for MACF only, single dedicated RAE or RAE-DZ for MACE and UL frame, duplicated RAE or RAE-DZ for MACF only, and duplicated RAE or RAE-DZ for MACF and UL frame.

In Example 35, the subject matter of any of Examples 26-34 can optionally include where the resource allocation for each of the plurality of stations to transmit the one or more third frames is indicated by one or more groups of stations of the plurality of stations.

In Example 36, the subject matter of any of Examples 26-35 can optionally include where the resource allocation is encoded in both the first frame and each of the one or more second frames, and wherein a transmission parameter set is encoded in only one of the first frame or each of the one or more second frames.

In Example 37, the subject matter of any of Examples 26-36 can optionally include where the access point and each of the plurality of stations is one from the following group: an Institute of Electrical and Electronic Engineers (IEEE) 802.11ax access point, an IEEE 802.11ax station, an IEEE 802.11 station, and an IEEE 802.11 access point.

In Example 38, the subject matter of any of Examples 26-37 can optionally include where the first frame comprises a trigger frame with a downlink resource allocation for the plurality of stations for the one or more second frames for one or both of DL OFDMA. or MU-MIMO.

In Example 39, the subject matter of Example 38 can optionally include means for transmitting and receiving radio signals.

Example 40 is a non-transitory computer-readable storage medium that stores instructions for execution by one or more processors. The instructions to configure the one or more processors to cause a station to: decode a first frame, wherein the first frame is a broadcast or multicast transmission, and decode a second frame for downlink (DL) orthogonal frequency division multiple-access (OFDMA), where the second frame comprises data for the station. The instructions to further configure the one or more processors to cause a station to: decode a resource allocation for the station to transmit a third frame comprising an acknowledge to the second frames in accordance with one or both of OFDMA or multiple user multiple-input multiple-output (MU-MIMO), where the resource allocation is encoded in one or both of the first frame and the second frame, encode an acknowledgment of the second frame, and configure the station to transmit the acknowledgement in accordance with the resource allocation.

In Example 41, the subject matter of Example 40 can optionally include where the instructions further configure the one or more processors to cause the access point to: decode a second resource allocation for the station to transmit a fourth frame in accordance with one or both of uplink (UL) OFDMA or MU-MIMO, where the second resource allocation is to be encoded in one or both of the first frame and the second frame.

In Example 42, the subject matter of Example 42 can optionally include where the acknowledgement is a multiple acknowledgment control frame (MACF).

Example 43 is a method performed on a station, the method including decoding a first frame, where the first frame is a broadcast or multicast transmission, and decoding a second frame for downlink (DL) orthogonal frequency division multiple-access (OFDMA), where the second frame comprises data for the station. The method further comprising decoding a resource allocation for the station to transmit a third frame comprising an acknowledge to the second frames in accordance with one or both of OFDMA or multiple user multiple-input multiple-output (MU-MIMO), where the resource allocation is encoded in one or both of the first frame and the second frame. The method further comprising encoding an acknowledgment of the second frame, and configuring the station to transmit the acknowledgement in accordance with the resource allocation.

In Example 44, the subject matter of Example 44 can optionally include decoding a second resource allocation for the station to transmit a fourth frame in accordance with one or both of uplink (TM) OFDMA or MU-MIMO, where the second resource allocation is to be encoded in one or both of the first frame and the second frame.

In Example 45, the subject matter of Examples 43 or 44 can optionally include where the acknowledgement is a multiple acknowledgment control frame NAM.

Example 46 is an apparatus of a station, the apparatus comprising: means for decoding a first frame, wherein the first frame is a broadcast or multicast transmission, means for decoding a second frame for downlink (DL) orthogonal frequency division multiple-access (OFDMA), where the second frame comprises data for the station, and means for decoding a resource allocation for the station to transmit a third frame comprising an acknowledge to the second frames in accordance with one or both of OFDMA or multiple user multiple-input multiple-output (MU-MIMO), where the resource allocation is encoded in one or both of the first frame and the second frame. The apparatus further including means for encoding an acknowledgment of the second frame, and means for configuring the station to transmit the acknowledgement in accordance with the resource allocation.

In Example 47, the subject matter of Example 47 can optionally include means for decoding a second resource allocation for the station to transmit a fourth frame in accordance with one or both of uplink (UL) OFDMA or MU-MIMO, where the second resource allocation is to be encoded in one or both of the first frame and the second frame.

In Example 48, the subject matter of Examples 46 or 47 can optionally include where the acknowledgement is a multiple acknowledgment control frame (MACF).

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point comprising memory; and processing circuitry coupled to the memory, the processing circuitry configured to:
encode a first frame for a broadcast or multicast transmission;
encode one or more second frames for one or both of downlink (DL) orthogonal frequency division multiple-access (OFDMA) or multiple user multiple-input multiple-output (MU-MIMO), wherein the one or more second frames comprise data for a plurality of stations, and wherein the one or more second frames are unicast frames;
encode a resource allocation for each of the plurality of stations to transmit one or more third frames comprising an acknowledge to the corresponding one or more second frames in accordance with one or both of OFDMA or MU-MIMO, wherein the resource allocation is to be encoded in one or both the first frame and each of the one or more second frames, wherein the resource allocation in each of the one or more second frames comprises the resource allocation for the corresponding station of the plurality of stations, and wherein the resource allocation comprises one or both of an OFDMA resource allocation or a MU-MIMO resource allocation;
configure the access point to transmit the first frame;
configure the access point to transmit the second frame; and
decode the one or more third frames comprising the acknowledgements from the plurality stations, wherein the acknowledgements are of the one or more second frames, and wherein the acknowledges are received in accordance with the resource allocation.

2. The apparatus of claim 1, wherein the resource allocation is encoded in either the first frame or the one or more second frames.

3. The apparatus of claim 2, wherein the first frame or the second frame comprises an aggregated media access control (MAC) protocol data unit (MPDU)(A-MPDU) comprising the resource allocation and one or more duplicated resource allocations encoded in the A-MPDU.

4. The apparatus of claim 1, wherein the processing circuitry is further configured to:
encode a second resource allocation for one or more of the plurality of stations to transmit one or more fourth frames in accordance with one or both of uplink (UL) OFDMA or MU-MIMO, wherein the second resource allocation is to be encoded in one or both of the first frame and one or more of the one or more second frames, wherein the second resource allocation in one or more of the one or more second frames comprises the second resource allocation for the corresponding station of the one or more stations of the plurality of stations.

5. The apparatus of claim 4, wherein the processing circuitry is further configured to:
encode a third resource allocation for one or more second stations to transmit one or more fifth frames in accordance with one or both of uplink (UL) OFDMA or MU-MIMO, wherein the third resource allocation is to be encoded in the first frame.

6. The apparatus of claim 5, wherein the first frame comprises a duration for a transmission opportunity and wherein the first frame, the one or more second frames, the one or more third frames, the one or more fourth frames, and the one or more fifth frames are to be transmitted in or within the transmission opportunity.

7. The apparatus of claim 1, wherein the first frame has a first bandwidth and the one or more second frames are transmitted on sub-channels of the first bandwidth.

8. The apparatus of claim 1, wherein the resource allocation is for a multiple acknowledgment control frame (MACF), and wherein the resource allocation comprises one or more of the following group of air access parameters: modulation and coding scheme (WS), number of spatial streams, and transmit power.

9. The apparatus of claim 1, wherein the resource allocation indicates one of the following group: a single dedicated resource allocation element (RAE) or RAE dedicated zone (RAE-DZ) for MACF only, single dedicated RAE or RAE-DZ for MACF and UL frame, duplicated RAE or RAE-DZ for MACF only, and duplicated RAE or RAE-DZ for MACF and UL frame.

10. The apparatus of claim 1, wherein the resource allocation for each of the plurality of stations to transmit the one or more third frames is indicated by one or more groups of stations of the plurality of stations.

11. The apparatus of claim 1, wherein the resource allocation is encoded in both the first frame and each of the one or more second frames, and wherein a transmission parameter set is encoded in only one of the first frame or each of the one or more second frames.

12. The apparatus of claim 1, wherein the access point and each of the plurality of stations is one from the following group: an Institute of Electrical and Electronic Engineers (IEEE) 802.11ax access point, an IEEE 802.11ax station, an IEEE 802.11 station, and an IEEE 802.11 access point.

13. The apparatus of claim 1, wherein the first frame comprises a trigger frame with a downlink resource allocation for the plurality of stations for the one or more second frames for one or both of DL OFDMA or MU-MIMO.

14. The apparatus of claim 13, further comprising transceiver circuitry coupled to the processing circuitry; and, one or more antennas coupled to the transceiver circuitry.

15. A non-transitory computer-readable storage medium that stores instructions for execution by one or more processors, the instructions to configure the one or more processors to cause an access point to:
encode a first frame for a broadcast or multi cast transmission;
encode one or more second frames for one or both of downlink (DL) multi-user multiple-input multiple-output (MU-MIMO) or DL orthogonal frequency division multiple-access (OFDMA), wherein the one or more second frames comprise data for a plurality of stations, and wherein the one or more second frames are unicast frames;
encode a resource allocation for each of the plurality of stations to transmit one or more third frames comprising an acknowledge to the corresponding one or more second frames in accordance with one or both of OFDMA or multiple user multiple-input multiple-output (MU-MIMO), wherein the resource allocation is to be encoded in one or both the first frame and each of the one or more second frames, wherein the resource allocation in each of the one or more second frames comprises the resource allocation for the corresponding station of the plurality of stations:
configure the access point to transmit the first frame;
configure the access point to transmit the second frame; and
decode acknowledgements from the plurality stations, wherein the acknowledgements are of the one or more second frames, and wherein the acknowledges are received in accordance with the resource allocation.

16. The non-transitory computer-readable storage medium of claim 15, wherein the instructions further configure the one or more processors to cause the access point to:
encode a second resource allocation for one or more of the plurality of stations to transmit one or more fourth frames in accordance with one or both of uplink WO OFDMA or MU-MIMO, wherein the second resource allocation is to be encoded in one or both of the first frame and one or more of the one or more second frames, wherein the second resource allocation in one or more of the one or more second frames comprises the second resource allocation for the corresponding station of the one or more stations of the plurality of stations.

17. The non-transitory computer-readable storage medium of claim 15, wherein the instructions further configure the one or more processors to cause the access point to:
encode a third resource allocation for one or more second stations to transmit one or more fifth frames in accordance with one or both of uplink (UL) OFDMA or MU-MIMO, wherein the third resource allocation is to be encoded in the first frame.

18. The non-transitory computer-readable storage medium of claim 15, wherein the first frame has a first bandwidth and the one or more second frames are transmitted on sub-channels of the first bandwidth.

19. The non-transitory computer-readable storage medium of claim 15, wherein the resource allocation is for a multiple acknowledgment control frame (MACF).

20. A method performed by an access point, the method comprising:
encoding a first frame for a broadcast or multicast transmission;
encoding one or more second frames for one or both of downlink (DL) multi-user multiple-input multiple-output (MU-MIMO) or DL orthogonal frequency division multiple-access (OFDMA), wherein the one or more second frames comprise data for a plurality of stations, and wherein the one or more second frames are unicast frames;
encoding a resource allocation for each of the plurality of stations to transmit one or more third frames comprising an acknowledge to the corresponding one or more second frames in accordance with one or both of OFDMA or multiple user multiple-input multiple-output (MU-MIMO), wherein the resource allocation is to be encoded in one or both the first frame and each of the one or more second frames, wherein the resource allocation in each of the one or more second frames comprises the resource allocation for the corresponding station of the plurality of stations;
configuring the access point to transmit the first frame;
configuring the access point to transmit the second frame; and
decoding acknowledgements from the plurality stations, wherein the acknowledgements are of the one or more second frames, and wherein the acknowledges are received in accordance with the resource allocation.

21. The method of claim 20, the method further comprising:
encoding a second resource al location for one or more of the plurality of stations to transmit one or more fourth frames in accordance with one or both of uplink (UL) OFDMA or MU-MIMO, wherein the second resource allocation is to be encoded in one or both of the first frame and one or more of the one or more second frames, wherein the second resource allocation in one or more of the one or more second frames comprises the second resource allocation for the corresponding station of the one or more stations of the plurality of stations.

22. An apparatus of a station comprising memory; and processing circuitry coupled to the memory, the processing circuitry configured to:
decode a first frame, wherein the first frame is a broadcast or multicast transmission:
decode a second frame for downlink (DL) orthogonal frequency division multiple-access (OFDMA), wherein the second frame comprises data for the station;
decode a resource allocation for the station to transmit a third frame comprising an acknowledge to the second frames in accordance with one or both of OFDMA or multiple user multiple-input multiple-output (MU-MIMO), wherein the resource allocation is encoded in one or both of the first frame and the second frame;
encode an acknowledgment of the second frame; and
configure the station to transmit the acknowledgement in accordance with the resource allocation.

23. The apparatus of claim 22, wherein the processing circuitry is further configured to:
decode a second resource allocation for the station to transmit a fourth frame in accordance with one or both of uplink (UL) OFDMA or MU-MIMO, wherein the second resource allocation is to be encoded in one or both of the first frame and the second frame.

24. The apparatus of claim 22, wherein the acknowledgement is a multiple acknowledgment control frame (MACF).

25. The apparatus of claim 22, further comprising transceiver circuitry coupled to the processing circuitry; and, one or more antennas coupled to the transceiver circuitry.
